(19) United States
(12) Patent Application Publication
(10) Pub. No.: US 2011/0170134 A1
(43) Pub. Date: Jul. 14, 2011

(54) IMAGE FORMING APPARATUS AND MAINTENANCE METHOD OF IMAGE FORMING APPARATUS

(75) Inventor: Hironaga Murashima, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/986,373

(22) Filed: Jan. 7, 2011

Related U.S. Application Data
(60) Provisional application No. 61/294,145, filed on Jan. 12, 2010.

(51) Int. Cl. G06F 3/12

(52) U.S. Cl. 358/1.15

(57) ABSTRACT

According to one embodiment, an image forming apparatus includes a log memory, an analysis unit, a determination unit, an extraction unit, and an output unit. The log memory stores error logs. The analysis unit analyzes an error content based on the logs stored in the log memory. The determination unit determines whether or not a notification of the error analyzed by the analysis unit is sent. The extraction unit extracts a log regarding the error for which the notification is sent, from the log memory, if the determination unit determines that the notification of the error is sent. The output unit outputs an error notification to which the log extracted by the extraction unit is attached.

### CROSS-REFERENCE TO RELATED APPLICATIONS

This application is based upon and claims the benefit of priority from U.S. Provisional Application No. 61/294,145 filed on Jan. 12, 2010; the entire contents of which are incorporated herein by reference.

### FIELD

Embodiments described herein relate generally to an image forming apparatus and a maintenance method of the image forming apparatus.

### BACKGROUND

In the related art, among image forming apparatuses such as multifunction printers, there is one having a function to store logs. The image forming apparatus outputs the stored logs in response to an operation by an administrator or a serviceman. The administrator or the serviceman analyzes the logs collected from the image forming apparatus individually. The image forming apparatus may have a function of sending a notification of the occurrence of an error when the error occurs. However, in the image forming apparatus in the related art, the log storage, the log collection, and the error notification are not connected to each other. For this reason, in the image forming apparatus in the related art, trouble analysis or trouble prediction by the administrator or the serviceman is not easy.

### BRIEF DESCRIPTION OF THE DRAWINGS

FIG. 1 is a diagram schematically illustrating a configuration example of an image forming system.

FIG. 2 is a block diagram illustrating a configuration example of a control system of a multifunction printer.

FIG. 3 is a diagram illustrating an example of setting regarding an error notification.

FIG. 4 is a flowchart illustrating a flow of an error notification process.

FIG. 5 is a flowchart illustrating the flow of the error notification process.

### DETAILED DESCRIPTION

In general, according to one embodiment, an image forming apparatus includes a log memory, an analysis unit, a determination unit, an extraction unit, and an output unit. The log memory stores error logs. The analysis unit analyzes an error content based on the logs stored in the log memory. The determination unit determines whether or not a notification of the error analyzed by the analysis unit is sent. The extraction unit extracts a log regarding the error for which the notification is sent, from the log memory, if the determination unit determines that the notification of the error is sent. The output unit outputs an error notification to which the log extracted by the extraction unit is attached.

Hereinafter, embodiments will be described in detail with reference to the accompanying drawings.

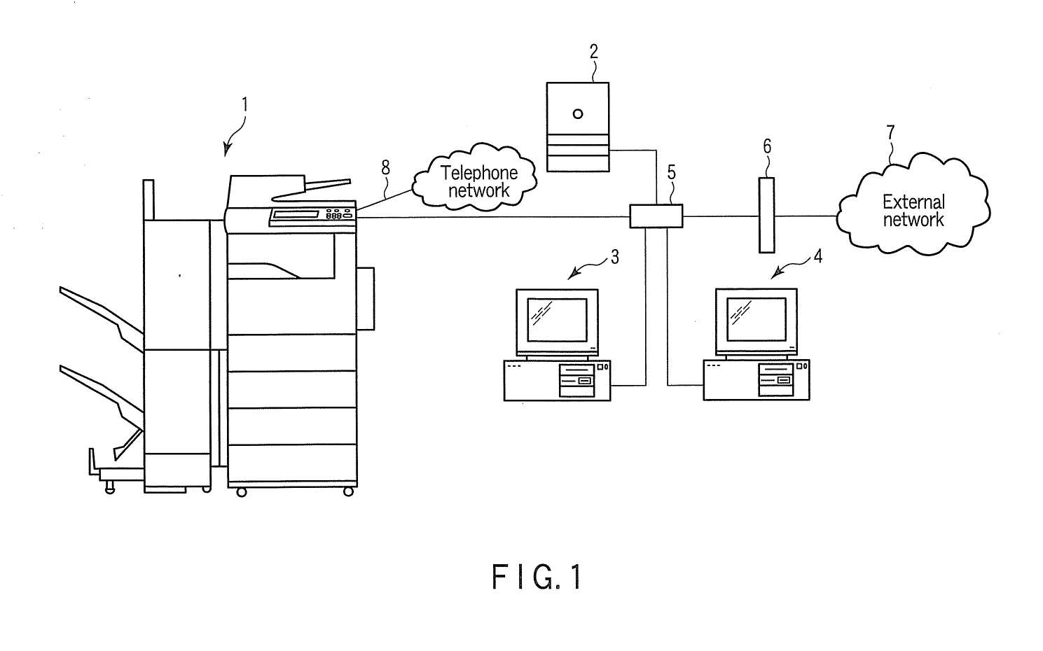

FIG. 1 is a diagram schematically illustrating a configuration example of an image forming system.

As shown in FIG. 1, a multifunction printer (MFP) 1 as an image forming apparatus has a function of connecting to a local area network. In the configuration example shown in FIG. 1, the multifunction printer 1 is connected to a server 2, a user terminal 3, and an administrator terminal 4 on the local area network via a router 5. The multifunction printer 1 is connected to an external network 7 via a firewall 6 connected to the router 5. Also, the multifunction printer 1 is connected to a telephone network via a telephone line 8.

The multifunction printer (MFP) 1 has a scanner function, a printer function, a copy function, a network communication function, a facsimile communication function, and the like. The multifunction printer 1 includes a system control unit having a processor, a memory, and an interface. The system control unit realizes various processing functions through the processor executing programs stored in the memory.

The server 2 is a server computer having a processor, a memory, an interface, and so forth. The server 2 performs data communication with the respective devices on the local area network via the router 5. The server 2 realizes various processing functions through the processor executing programs stored in the memory.

The user terminal 3 is a terminal device which is used by a user. The user terminal 3 has a processor, a memory, an interface, an operation unit, a display unit, and the like. The user terminal 3 performs data communication with the respective devices on the local area network, connected via the router 5. The user terminal 3 realizes various processing functions through the processor executing programs stored in the memory. The user terminal 3 is, for example, a personal computer. Also, the user terminal 3 may be a portable terminal device which can communicate with the multifunction printer 1.

The administrator terminal 4 is a terminal device which is used by an administrator. The administrator terminal 4 has a processor, a memory, an interface, an operation unit, a display unit, and the like. The administrator terminal 4 performs data communication with the respective devices on the local area network, connected via the router 5. The administrator terminal 4 realizes various processing functions through the processor executing programs stored in the memory. The administrator terminal 4 may be any other device which can communicate with the multifunction printer 1. The administrator terminal 4 is constituted by, for example, a personal computer, or the like. The administrator terminal 4 may be a portable terminal device which can communicate with the multifunction printer 1.

Next, a configuration of the multifunction printer 1 will be described.

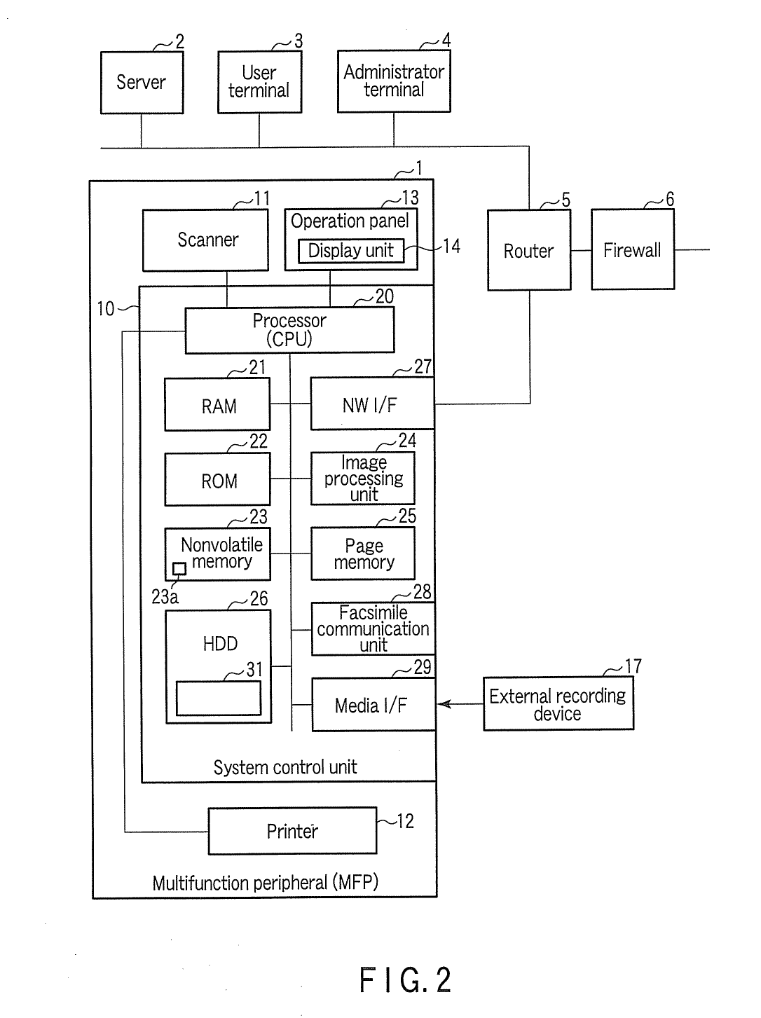

FIG. 2 is a block diagram illustrating a configuration example of a control system of the multifunction printer 1.

As shown in FIG. 2, the multifunction printer 1 has a system control unit 10, a scanner 11, a printer 12, an operation panel 13, and a display unit 14. The system control unit 10 collectively controls the respective units in the multifunction printer 1. The system control unit 10 is connected to the scanner 11, the printer 12, the operation panel 13, and the display unit 14.

For example, if a user gives an instruction for a copying job using the operation panel 13, the system control unit 10 performs copying by controlling the scanner 11 and the printer 12. Also, if the user instructs a scan job using the operation panel 13, the system control unit 10 performs scanning by controlling the scanner 11. If the user requests a print job from the user terminal 3, the system control unit 10 performs printing by controlling the printer 12.

The scanner 11 is an image obtaining unit which converts an image on an original document into image data. For example, the scanner 11 optically scans the original document and thus reads an image on the original document as color image data or monochrome image data. The scanner 11 has a scanning mechanism, a photoelectric conversion unit, an automatic document feeder (ADF), and so forth. The printer 12 is an image forming unit which forms images on a recording medium, such as paper. For example, the printer 12 forms color images or monochrome images on paper. The printer 12 may form images by a printing method such as an electro-photographic method, an inkjet method, or a thermoelectronic method.

The operation panel 13 is a user interface. The operation panel 13 has, for example, various kinds of operation keys, the display unit 14 in which a touch panel is embedded, and so forth. The operation panel 13 functions as an operation unit used for a user to input operation instructions, and a display unit which displays guides for the user, or the like. For example, the operation panel 13 is used not only to instruct setting and execution of a job (process) content but also for an administrator or a serviceman to input information for setting regarding the multifunction printer.

The system control unit 10 includes a processor (CPU) 20, a random access memory (RAM) 21, a read only memory (ROM) 22, a nonvolatile memory 23, an image processing unit 24, a page memory 25, a hard disc drive (HDD) 26, a network interface (NW I/F) 27, a facsimile communication unit 28, a media interface (I/F) 29, and so forth.

The processor 20 is, for example, a CPU. The processor 20 realizes various kinds of processing functions by executing control programs stored in the ROM 22, the nonvolatile memory 23, or the HDD 26. The RAM 21 is a main memory which functions as a work memory. The ROM 22 stores controls programs, control data, and so forth, used to operate the multifunction printer 1. The nonvolatile memory 23 is a rewritable nonvolatile memory. The nonvolatile memory 23 stores control programs, control data, and so forth, used to realize various kinds of processing functions.

The nonvolatile memory 23 has a storage area 23a which stores information indicating device settings of the current multifunction printer 1 (device setting information). Device settings refer to settings regarding fundamental operations of the multifunction printer 1. The device settings are different from settings (process settings) regarding an individually performed job (copying, scanning, printing, or the like). The device settings include, for example, settings regarding an error notification (hereinafter, also referred to as “error notification setting”). In this multifunction printer 1, error notification setting information indicating the error notification setting is assumed to be recorded as a portion of the device setting information in the storage device 23a. In addition, the device setting information such as the error notification setting information may be stored in the HDD 26.

The image processing unit 24 processes image data which is read by the scanner 11 or image data received via the network. The page memory 25 is a memory having a storage region in which image data of at least an amount of one page is developed. The HDD 26 is a large capacity of memory for storing data. The HDD 26 stores, for example, image data to be printed. Also, the HDD 26 has a log database 31 which stores information or the like indicating the state when an error occurs as a log (an error log). The log database 31 may be provided in the nonvolatile memory 23.

The network interface (NW I/F) 27 is an interface used to perform data communication with the respective units on the local area network via the router 5. The facsimile communication unit 28 is an interface used to perform facsimile communication using the telephone line. The media interface (I/F) 29 is an interface used to be directly (locally) connected to an external storage device M such as a memory device, a memory card, or the like.

Next, the settings regarding error notification in the multifunction printer 1 will be described.

The error notification setting information indicating the settings regarding the error notification in this multifunction printer 1 are stored in the storage area 23a of the nonvolatile memory 23. The error notification setting is to set contents of a notification sent to an administrator or a serviceman according to the error content. The error notification setting is designated by the administrator or the serviceman. The error notification setting sets processing contents preformed as an error notification such as the conditions of the error notification, the content of the error notification, and the method of the error notification for each error type (category).

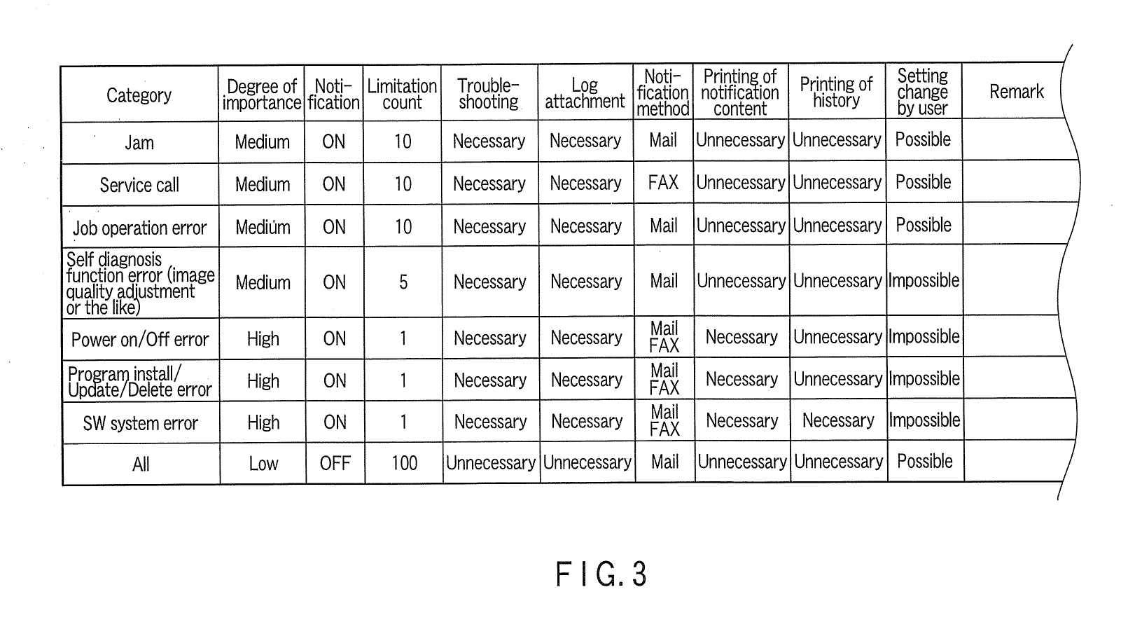

FIG. 3 is an example of the error notification setting information.

As shown in FIG. 3, the multifunction printer 1 can hold different error notification settings for each error category. In the error notification setting information shown in FIG. 3, error categories where notification contents can be set individually are classified into eight categories. The error notification setting information as shown in FIG. 3 is stored in, for example, the storage area 23a of the nonvolatile memory 23. In the example shown in FIG. 3, the storage area 23a stores information such as a degree of importance, notification or not, a limitation count, troubleshooting or not, log attachment or not, the notification method, printing or not of notification contents, printing or not of history, setting change by a user or not, and remark information, as the error notification setting information, for each error category.

In the example shown in FIG. 3, the error categories include “jam,” “service call,” “job operation error,” “self diagnosis function error,” “power ON and OFF error,” “program install, update or delete error,” “SW system error,” and “all.”

A “jam” is a paper jamming error in the system which carries paper used to print images or original document paper. A “job operation error” is a processing error in copying, Internet facsimile, scanning, printing, or the like. A “self diagnosis function error” is an error in a self diagnosis function such as image quality adjustment, or the like. An “SW system error” is an error excluding the above-described errors, and includes errors which are determined to cause serious damage to the system. For example, an HDD error is classified as the “SW system error.” “All” indicates all the above-described errors.

In the example of the error notification setting information shown in FIG. 3, the “degree of importance” indicates the degree of importance as an error in the error of the corresponding category. The “notification or not” indicates setting regarding whether or not to send a notification of the error of the corresponding category. The “limitation count” is a threshold value used to determine a notification of the error of the corresponding category. For example, a notification of the error of the corresponding category is set to be sent if the number of occurrences exceeds the “limitation count.”

The “troubleshooting or not” indicates whether or not to attach troubleshooting regarding the corresponding error to the error notification. The troubleshooting indicates explanation indicating a possibility of trouble of a device (part) predicted from the content of the error notification and the handling method of the error. A content of the troubleshooting may be stored in the HDD 26 so as to correspond to an error content, or may be obtained from an external device (for example, the server 2) via the network.

The “log attachment or not” indicates whether or not to attach log information regarding the error to the error notification. An attached log may be all logs regarding the error or a log summarized under a certain condition (period of time or the like). In addition, the information attached as a log may be information extracted from the respective logs regarding the error. The content of the attached log may be set by the administrator or the serviceman.

The attached logs may be collected in an external device such as the server 2 which can communicate via the network by the network interface 27. In this case, the multifunction printer 1 set information indicating that logs attached to the error notification are collected in an external device such as the server 2 which can communicate via the network. Thereby, the multifunction printer 1 can transmit (collect) logs attached to the error notification to an external device set in advance via the network. In addition, attached logs may be collected in an external storage device (a memory device, a memory card, or the like) connected to the media interface 29. In this case, the multifunction printer 1 sets information indicating that logs attached to the error notification are stored in the external storage device. Thereby, the multifunction printer 1 can store the logs attached to the error notification in the external storage device.

The “notification method” indicates a method of the error notification. In the example of the error notification setting information shown in FIG. 3, a method of the error notification in the multifunction printer 1 is assumed to include an electronic mail (hereinafter, simply referred to as a “mail”) and a facsimile. The mail and facsimile are set to be transmitted by the administrator or the serviceman. A mail address or a facsimile number of the administrator or the serviceman may be stored in the remark column, or may be stored in an address field provided in the HDD 26 or the nonvolatile memory 23. A mail address or a facsimile number of the administrator or the serviceman may be stored in the server 2 or the like which can be accessed via the network.

The “printing or not of a notification content” indicates whether or not to print the error notification content. The printed notification content may be the same content as notification content sent by a mail or a facsimile. That is to say, the printed notification content includes the text of the mail or the facsimile, the attached logs, and the attached troubleshooting. In addition, the printed notification content may omit the text of the logs or the troubleshooting.

The “printing or not of history” indicates whether or not to print history information regarding the error notification, such as the history of an error notification, history of log notification, history of log collection, and history of printing of notification content. For example, the printing of history information regarding the error notification may include printing of information expressing error notifications sent in the past in list form.

The “setting change by a user or not” indicates whether or not a user can change (select) setting regarding the error notification. The “setting change by a user or not” is designated for each error category by the administrator or the serviceman. That is to say, the administrator or the serviceman can set whether or not a user other than the administrator or the serviceman can change the settings regarding the error notification. In other words, the multifunction printer 1 can set compulsory settings by the administrator or the serviceman (settings cannot be changed by a user other than an administrator or a serviceman).

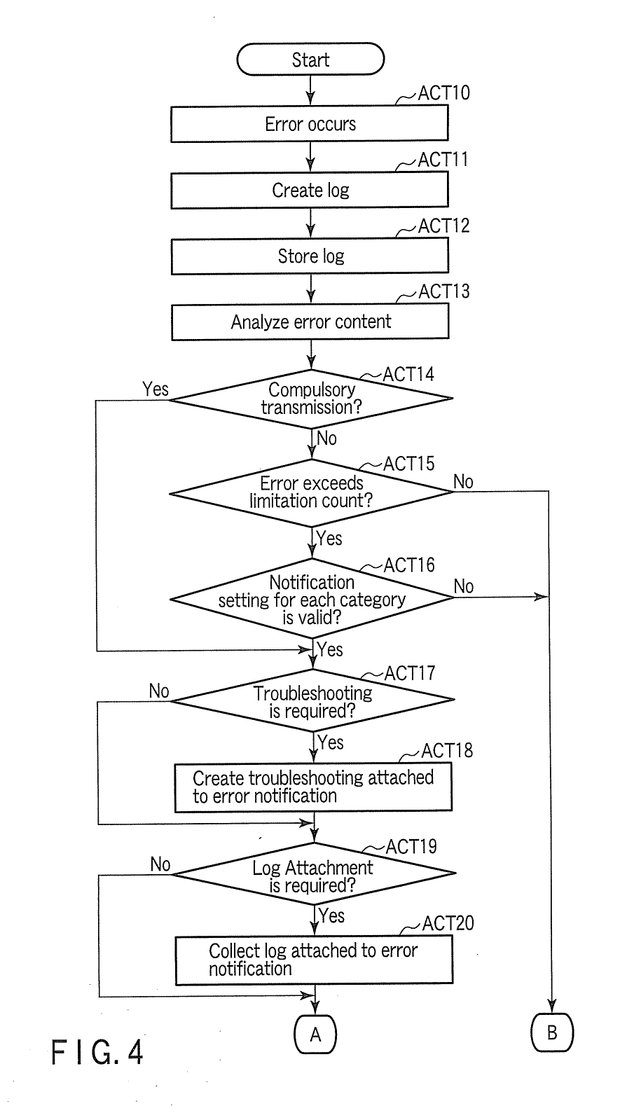

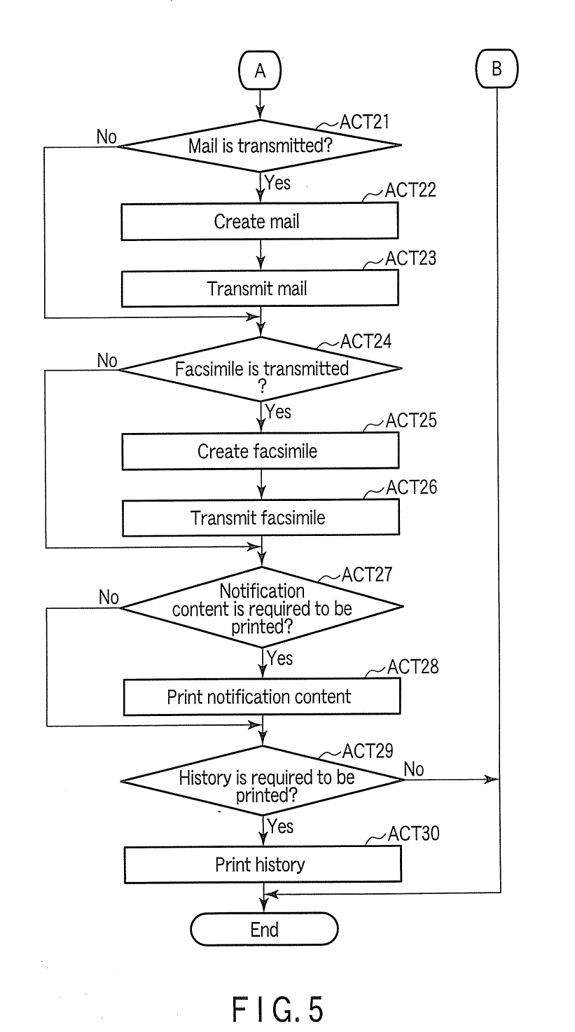

FIGS. 4 and 5 are flowcharts illustrating a flow of an error notification process in the multifunction printer 1.

First, it is assumed that an error occurs in the multifunction printer 1. The processor 20 in the system control unit 10 detects an error which occurred in the multifunction printer 1 based on information obtained from the respective units in the multifunction printer 1 (Act 11).

If an error occurs, the processor 20 creates log information (error log) indicating the error content. The processor 20 stores the created error log in the log database 31 in the HDD 26 (ACT 12). The processor 20 creates the error log including information indicating the content of the error which occurred and information indicating the situation when the error occurred. The error log content may be decided depending on the error type.

For example, if the error which occurred is an error regarding the HDD, the processor 20 creates an error log including temperature of the HDD itself, a written count, an activation count, an error count, and so forth. Also, if the system of the multifunction printer is locked and thus an operation using the operation panel is disabled, the processor 20 creates an error log including a core dump of an operating system (OS), a system log, and so forth. Also, if a jam occurs during printing, the processor 20 creates an error log including the accumulated number of sheets of passed paper, the maintenance situation of carrying rollers, and so forth.

If the created logs are stored, the processor 20 analyzes an error content based on the logs stored in the log database 31 (ACT 13). For example, the processor 20 determines the category of the error which occurred based on the logs stored in the log database 31, or determines the accumulated value of the error occurrence count for each category.

If the error content is analyzed, the processor 20 determines if the error is one where a compulsory notification of the content of the error which occurred is to be sent (ACT 14). For example, the processor 20 determines fatal errors in the operation of the multifunction printer 1 as errors for which a compulsory notification is to be sent. The errors for which a compulsory notification is to be sent may be set in advance independently from the error notification setting information. In addition, the highest error in the degree of importance may be set as an error for which a compulsory notification is to be sent, or an error for which the limitation count is one may be set as an error for which a compulsory notification is to be sent in the error notification setting information.

If determining that the error which occurred is not an error for which a compulsory notification is to be sent (ACT 14, NO), the processor 20 determines whether or not the accumulated value of the error occurrence count for each category exceeds the limitation count for the category (ACT 15). The processor 20 determines whether or not, with respect to the error category obtained as a result of analyzing the error content, the error occurrence count exceeds the limitation count for the category in the error notification setting.

If the error occurrence count exceeds the limitation count (ACT 15, YES), the processor 20 determines whether or not, with respect to the category of the error which occurred, the error notification is ON (valid) (ACT 16). If the error occurrence count does not exceed the limitation count (ACT 15, NO), or if the error notification is OFF (invalid) in the category of the error which occurred (ACT 16, NO), the processor 20 does not send a notification of the error and finishes the process.

If the error notification is ON (valid) in the category of the error which occurred (ACT 16, YES), the processor 20 determines whether or not troubleshooting is required to be attached to the notification of the error which occurred (error notification) (ACT 17). For example, the processor 20 determines whether or not the error notification for the category of the error which occurred is set to require the troubleshooting in the error notification setting information.

If determining that the troubleshooting is required to be attached to the error notification (ACT 17, YES), the processor 20 creates troubleshooting to be attached to the error notification (ACT 18). The processor 20 creates the troubleshooting regarding the error which occurred with reference to troubleshooting according to error contents stored in the HDD 26.

If the error notification is ON (valid) in the category of the error which occurred (ACT 16, YES), the processor 20 determines whether or not logs are required to be attached to the error notification (ACT 19). For example, the processor 20 determines whether or not the error notification for the category of the error which occurred is set to require log attachment in the error notification setting information.

If determining that logs are required to be attached to the error notification (ACT 19, YES), the processor 20 extracts (collects) logs to be attached to the error notification from the log database 31 (ACT 20). The extracted logs (logs to be attached to the error notification) relate to the errors for which a notification is sent. For example, the processor 20 may extract information regarding the error content from the respective logs stored in the log database 31, and sets the extracted information as the log information to be attached to the error notification.

The processor 20 determines whether or not notification of the error which occurred is sent by a mail (ACT 21). For example, the processor 20 determines whether or not a method of the error notification for the category of the error which occurred is set to the mail in the error notification setting information. If determining that the error notification is sent by the mail (ACT 21, YES), the processor 20 creates a mail (mail data) used to notify the administrator or the serviceman of the error (ACT 22).

For example, the processor 20 creates a mail message regarding notification of the error which occurred. The processor 20 attaches the troubleshooting created according to the settings and the logs collected according to the settings to the created mail. The processor 20 sets a mail address of the administrator or the serviceman as a recipient in the mail to which the troubleshooting and the logs are attached according to the settings. If creating the error notification mail to which the troubleshooting and the logs are attached according to the settings, the processor 20 transmits the mail to the administrator or the serviceman (ACT 23).

In addition, the processor 20 determines whether or not notification of the error which occurred is sent by a facsimile (ACT 24). For example, the processor 20 determines whether or not a method of the error notification for the category of the error which occurred is set to a facsimile in the error notification setting information. If determining that the error notification is sent by a facsimile (ACT 24, YES), the processor 20 creates facsimile data which notifies the administrator or the serviceman of the error (ACT 25).

For example, the processor 20 creates a facsimile document message regarding the notification of error which occurred. The processor 20 attaches the troubleshooting created according to the settings and the logs collected according to the settings to the created facsimile document. If creating the error notification facsimile document to which the troubleshooting and the logs are attached according to the settings, the processor 20 transmits the facsimile document to the administrator or the serviceman by the facsimile (ACT 26).

If the error notification is sent by the mail or the facsimile, the processor 20 determines whether or not the error notification content is printed by the printer 12 of the multifunction printer 1 (ACT 27). For example, the processor 20 determines whether or not the notification content for the category of the error which occurred is set to require printing in the error notification setting information. If determining that the error notification content is printed (ACT 27, YES), the processor 20 prints the content of the mail or the facsimile transmitted as the error notification.

For example, if creating the error notification mail, the processor 20 develops the logs and the troubleshooting attached to the mail in printing data along with the text of the mail. The processor 20 prints the text of the mail, the attached logs and troubleshooting which are developed in the printing data, on paper using the printer 12.

In addition, if the error notification is sent by the mail or the facsimile, the processor 20 determines whether or not history of the error notification is printed using the printer 12 of the multifunction printer 1 (ACT 29). For example, the processor 20 determines whether or not the history of the error notification is set to require printing in the error notification setting information. If determining that the history of the error notification is printed (ACT 29, YES), the processor 20 prints the history of the error notification which represents the content of error notifications performed in the past in list form (ACT 30). If the history of the error notification is printed, the processor 20 stores history information indicating an error notification content for each error notification in the HDD 26 or the like.

The processor 20 may output the logs extracted according to the error content to an external device such as the server 2 or the administrator terminal 4 via the network by the network interface 27. In this case, the processor 20 sends a notification indicating that the logs are stored in the external device via the network, in the error notification mail or facsimile. In addition, the processor 20 may store the logs extracted according to the error content in an external storage device (a memory device, a memory card, or the like) connected to the media interface 29. In this case, the processor 20 sends a notification indicating that the logs are stored in the external storage device in the error notification mail or facsimile.

As described above, the multifunction printer stores error logs indicating the state when the error occurred in the log database. The multifunction printer determines if an error notification is required or not and if the attachment of the log to the error notification is required or not based on the analysis of the error logs. If it is determined that the logs are to be attached to the error notification, the multifunction printer extracts (collect) log data regarding the error from the database, and transmits an error notification mail or facsimile to which the extracted log data is attached to the administrator or the serviceman.

According to the above-described multifunction printer, it is possible not only to send a simple error notification indicating that an error occurred, but also to notify the administrator or the serviceman of an error log regarding the error, and to promote an action such as prompt trouble analysis or trouble prediction.

In addition, this multifunction printer can set an error notification content such as the attachment of logs for each error category. According to the multifunction printer, it is possible to send an error notification according to the error type, working types of the multifunction printer, and the like.

Hereinafter, processing examples to which the above-described processes are applied will be described.

As a first processing example, a process when an error regarding the HDD 26 occurs will be described.

If an error regarding the HDD 26 occurs, the processor 20 stores information (for example, temperature, a written count, an activation count, an error count, and so forth) indicating an error occurrence situation in the log database 31 of the HDD 26 as an error log. If the error log is stored in the log database 31, the processor 20 determines whether or not the number of errors regarding the HDD reaches a limitation count for an error notification. If the error number reaches the limitation count, and if an error notification using a mail related to the error in the HDD is valid, the processor 20 confirms the settings of the troubleshooting and the attachment of logs.

If the settings of the attachment of logs are valid, the processor 20 extracts error logs regarding the HDD from the database 31, as the logs attached to the error notification mail. If the settings of the attachment of the troubleshooting are valid, the processor 20 creates troubleshooting including a statement indicating the possibility of HDD trouble and a handling method. If the attachment of the troubleshooting and the attachment of the logs are set together, the processor 20 transmits an error notification mail to which the extracted logs and the created troubleshooting are attached to the administrator or the serviceman.

Like in the first processing example, the multifunction printer can transmit the error notification mail to which the related error logs and troubleshooting are attached to the administrator or the serviceman if the error occurrence count regarding the HDD exceeds the limitation count. The multifunction printer can set whether the error logs are attached or the troubleshooting is attached to the error notification which is a notification of the error content regarding the HDD.

In a second processing example, a process when a fatal error occurs causing the system of the multifunction printer 1 to become locked and operation of the operation panel to become impossible will be described.

If the system of the MFP is locked, and an operation of the operation panel is impossible, the processor 20 stores information (for example, a core dump of the OS, a system log, or the like) indicating the error occurrence situation in the database 31 of the HDD 26 as an error log. The processor 20 determines an error causing the system to be locked and an operation to the operation panel to be impossible as a fatal error. For example, a compulsory notification of the fatal error is set to be sent to the serviceman by a facsimile after just once occurrence. In this case, the processor 20 stores an error log of the fatal error in the log database 31 and confirms settings of the troubleshooting and the log attachment.

If the settings of the log attachment are valid, the processor 20 extracts a log for analyzing the fatal error from the database 31, as a log attached to a facsimile document (image data for use in facsimile transmission) for the error notification. If the settings of the troubleshooting attachment are valid, the processor 20 creates troubleshooting regarding the error. If the troubleshooting attachment and the log attachment are set together, the processor 20 transmits the error notification facsimile document to which the extracted log and the created troubleshooting are attached (additionally recorded) to the serviceman.

Like in the second processing example, the multifunction printer can instantly transmit the error notification facsimile to which the related error log or troubleshooting are attached to the serviceman by the fatal error occurring just once. The multifunction printer can set whether the error log is attached or the troubleshooting is attached to the error notification regarding the fatal error for which a notification is sent after just once occurrence.

As a third processing example, a process when a jam occurs will be described.

If a jam occurs during the printing, the processor 20 stores information (for example, the place in which the jam occurs, a print mode, the accumulated number of sheets of passed paper, the maintenance situation of carrying rollers, and so forth) indicating the jam occurrence situation in the log database 31 of the HDD 26, as an error log. If the error log regarding the jam is stored in the log database 31, the processor 20 determines whether or not the error number regarding the jam reaches the limitation count for the error notification. If the error count reaches the limitation count and if the error notification by a mail regarding the jam error is valid, the processor 20 confirms the settings of the troubleshooting and log attachments.

If the settings of the log attachment are valid, the processor 20 extracts an error log regarding the jam from the database 31, as a log attached to an error notification mail. The processor 20 may extract log information for analyzing the jam according to jam types (the place in which the jam occurs, or the like) from the log database 31. If the settings of the troubleshooting attachment are valid, the processor 20 creates troubleshooting including the handling method of the jam. The processor 20 selects handling methods according to the jam types. If the troubleshooting attachment and the log attachment are set together, the processor 20 transmits the error notification mail to which the extracted log and the created troubleshooting are attached to the administrator or the serviceman.

Like in the third processing example, if the error occurrence count regarding the jam exceeds the limitation count, the multifunction printer can transmit the error notification mail to which the log for analyzing the jam and the troubleshooting indicating handling method of the jam are attached to the administrator or the serviceman. The multifunction printer can set whether the error log is attached or the troubleshooting is attached to the error notification which is a notification of the error content regarding the jam.

As a fourth processing example, a process when a SW system error occurs non-consecutively (non-periodically) will be described.

For example, it is assumed that the SW system error occurs once a month in the multifunction printer. If the SW system error occurs, the processor 20 stores information (for example, a core dump of the OS, a system log, and the like) indicating the error occurrence situation in the log database 31 of the HDD 26, as an error log. If an error notification regarding the SW system error is valid, the processor 20 confirms setting of troubleshooting and log attachments.

If the settings of the log attachment is valid, the processor 20 extracts (collects) an error log regarding the occurred SW system error from the database 31, as a log attached to an error notification mail. If the settings of the troubleshooting attachment are valid, the processor 20 creates troubleshooting including a handling method of the occurred SW system error. If the troubleshooting attachment and the log attachment are set together, the processor 20 transmits the error notification to which the extracted log and the created troubleshooting are attached to the administrator or the serviceman by a mail or a facsimile.

As in the fourth processing example, the multifunction printer can set the error notification to which the related log or troubleshooting is attached, with respect to the SW system error which occurs non-periodically, as well. The multifunction printer can output the error notification to which the log regarding the error is attached even in an error occurring non-periodically. If the multifunction printer performs the above-described error notification, the administrator or the serviceman can finely inspect even an error occurring non-periodically based on the log attached to the error notification. For example, the administrator or the serviceman can easily or accurately grasp the cause, occurrence frequency, occurrence conditions, or the like of an error occurring non-periodically, from the log attached to the error notification. Additionally, if the cause of the error becomes clear through the inspection results of the log attached to the error notification, the administrator or the serviceman can initially solve problems in the multifunction printer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
a log memory that stores error logs;
an analysis unit that analyzes an error content based on the logs stored in the log memory;
a determination unit that determines whether or not a notification of the error analyzed by the analysis unit is sent;
an extraction unit that extracts a log regarding the error for which the notification is sent, from the log memory, if the determination unit determines that the notification of the error is sent; and
an output unit that outputs an error notification to which the log extracted by the extraction unit is attached.

2. The apparatus of claim 1, further comprising a notification setting unit that sets a notification content according to an error content,
wherein if the determination unit determines that the notification of the error is sent, and if the notification setting unit sets logs to be attached as notification content of the error, the extraction unit extracts a log regarding the error for which the notification is sent from the log memory, and
wherein the output unit attaches the log extracted by the extraction unit to the error notification according to a content of the error notification set by the notification setting unit.

3. The apparatus of claim 2, further comprising a creation unit that creates troubleshooting regarding the error content analyzed by the analysis unit if the notification setting unit sets troubleshooting to be attached as a notification content of the error,
wherein the notification setting unit sets whether or not troubleshooting is attached as a notification content according to the error content, and
the output unit attaches the troubleshooting created by the creation unit to the error notification according to the error notification content set by the notification setting unit.

4. The apparatus of claim 2, wherein the notification setting unit sets contents to be analyzed as error contents based on the logs stored in the log memory, and
the analysis unit analyzes logs according to contents set by the notification setting unit.

5. The apparatus of claim 4, wherein the notification setting unit sets the notification content for each error category, and
the analysis unit analyzes error categories stored as logs in the log memory.

6. The apparatus of claim 5, wherein the notification setting unit sets whether or not the error notification is sent by an electronic mail, and
the output unit outputs an electronic mail to which a log is attached according to a content set by the notification setting unit, as the error notification.

7. The apparatus of claim 5, wherein the notification setting unit sets whether or not the error notification is sent by a facsimile, and
the output unit outputs a facsimile to which a log is attached according to a content set by the notification setting unit, as the error notification.

8. The apparatus of claim 5, wherein the output unit outputs the error notification and causes the log extracted by the extraction unit to be collected in an external device which is connected via a network.

9. The apparatus of claim 5, wherein the output unit outputs the error notification and causes the log extracted by the extraction unit to be collected in an external storage device.

10. The apparatus of claim 5, wherein the notification setting unit sets whether or not a setting change of notification contents by a user is allowed for each error category.

11. The apparatus of claim 5, further comprising a printer that prints a content of the error notification including a content of the attached log.

12. The apparatus of claim 5, further comprising a printer that prints a history of the error notification output by the output unit.

13. A maintenance method of an image forming apparatus, comprising:
storing error logs in a log memory;
analyzing an error content based on the logs stored in the log memory;
determining whether or not a notification of the error obtained by analyzing the error content based on the logs is sent;
extracting a log regarding the error for which the notification is sent, from the log memory, if it is determined that the notification of the error is sent; and
outputting an error notification to which the extracted log is attached.

14. The method of claim 13, further comprising setting a notification content according to an error content in the error notification,
wherein if a log of an error is set to be attached in setting of the notification content, a log regarding the error for which the notification is sent is extracted from the log memory, and
the log extracted according to the settings of the notification content is attached to the output error notification.

15. The method of claim 14, further comprising setting whether or not troubleshooting is attached as a notification content according to the error content,
wherein if troubleshooting is set to be attached in the settings of the notification content, troubleshooting regarding the analyzed error content is created, and
the troubleshooting created according to the settings of the notification content is attached to the output error notification.

16. The method of claim 14, further comprising setting contents to be analyzed as error contents based on the logs stored in the log memory,
wherein the analysis is performed by analyzing logs according to the settings of the notification content.

17. The method of claim 16, wherein the notification content is set for each error category, and
the analysis is performed by analyzing error categories stored as logs in the log memory.

18. The method of claim 17, wherein whether or not the error notification is sent by an electronic mail is set as the notification content, and
the electronic mail to which a log is attached is output, as the error notification, if the error notification is set to be sent by the electronic mail.

19. The method of claim 17, wherein whether or not the error notification is sent by a facsimile is set as the notification content, and
the facsimile to which a log is attached is output as the error notification, if the error notification is set to be sent by the facsimile.

20. The method of claim 17, further comprising printing a content of the error notification including a content of the attached log.
